(19) United States
(12) Patent Application Publication
(10) Pub. No.: US 2008/0275153 A1
(43) Pub. Date: Nov. 6, 2008

(54) UV curable resin, its preparation and composition containing the same

(75) Inventors: Kuen-Yuan Hwang, Hsinchu (TW); An-Pang Tu, Hsinchu (TW); Ping-Chieh Wang, Hsinchu (TW); Chie-Wei Yang, Hsinchu (TW)

Correspondence Address: BACON & THOMAS, PLLC, 625 SLATERS LANE, FOURTH FLOOR, ALEXANDRIA, VA, 22314-1176, US

(73) Assignee: CHANG CHUN PLASTICS CO., LTD., Taipei (TW)

(21) Appl. No.: 11/889,788

(22) Filed: Aug. 16, 2007

(30) Foreign Application Priority Data
May 4, 2007 (TW) 096115824

(51) Int. Cl. C08F 2/48

(52) U.S. Cl. 522/31; 522/103; 522/40; 522/43; 522/44; 522/46; 522/48; 522/53; 522/55; 522/64; 522/65; 522/70

(57) ABSTRACT

The present invention relates to an ultraviolet curable resin of the present invention which is prepared from alkyl(meth)acrylates, glycidyl(meth)acrylate, and substituted or unsubstituted acrylic acid, wherein the resin contains terminal vinyl group in amount of at least 50 wt % based on the resin and its glass transition temperature (Tg) is in a range of from 40˜100° C. The present invention also relates to a resin composition containing the ultraviolet curable resin.

This Non-provisional application claims priority under 35 U.S.C. §119(a) on Patent Application No(s). 096115824 filed in Taiwan, Republic of China on May 4, 2007, the entire contents of which are thereby incorporated by reference.

### FIELD OF THE INVENTION

The present invention relates to a ultraviolet curable resin, which is prepared from a (meth)acrylate, a glycidyl(meth)acrylate, and a substituted or unsubstituted acrylic acid, wherein the resin contains terminal vinyl group in amount of at least 50 wt % based on the resin and its glass transition temperature (Tg) is in a range of from 40˜100° C. The present invention also relates to a resin composition containing the ultraviolet curable resin, the resin composition is useful as a surface hardcoat on a substrate and attributes the substrate with high hardness, anti-scratching, anti-wearing, and anti-static properties.

### BACKGROUND OF THE INVENTION

Substrates and articles produced from material such as poly(methyl acrylate)(PMMA) resins, polycarbonate (PC) resins, and polyethylene terephthalate (PET) resins are easily scratched and damaged due to its low surface hardness. Thus, the substrates and articles made from the material are usually applied with hardcoat on their surface, subjected to UV or thermal treatment to improve the surface hardness of the substrates and articles and attribute them with anti-scratching, anti-wearing properties, etc., and decrease their damage from external surrounding. Moreover, the hardcoat applied on the surface of the substrates and articles would provide anti-static and anti-dusting effects.

However, the transparency of such hardcoats is still not satisfied. Therefore, the present inventors have focused on the development of hardcoat with satisfactory both hardness and transparency, and thus completed the present invention.

### SUMMARY OF THE INVENTION

The present invention relates to an ultraviolet curable resin, which is prepared from a (meth)acrylate, a glycidyl(meth)acrylate, and a substituted or unsubstituted acrylic acid, wherein the resin contains terminal vinyl group in amount of at least 50 wt % based on the resin and its glass transition temperature (Tg) is in a range of from 40˜100° C.

The present invention also relates to an ultraviolet curable resin composition, which comprises the present ultraviolet curable resin and one or more photoinitiators, wherein the photoinitiators are contained in the resin composition in an amount of from 0.1 to 10 parts by weight, based on the total weight of the composition as 100 parts by weight.

The resin composition is useful as a surface hardcoat on a substrate and attributes the substrate with high hardness, anti-scratching, anti-wearing, and anti-static properties.

The ultraviolet curable resin can be prepared by addition reaction of a (meth)acrylate with a glycidyl(meth)acrylate to obtain an intermediate having epoxy group, then subjecting to a ring-opening reaction between the epoxy of the intermediate and a carboxy group of an unsubstituted or substituted acrylic acid to obtain ultraviolet curable resin containing terminal vinyl group, wherein the amount of the terminal vinyl group contained in the resin is at least 50% by weight, preferably at least 70% by weight, relative to total weight of the resin, and Tg of the resin is in a range of from 40˜100° C., preferably from 60˜90° C.

The ultraviolet curable resin can be prepared by addition reaction of a (meth)acrylate with a unsubstituted or substituted acrylic acid to obtain an intermediate having carboxy group, then subjecting to a ring-opening reaction between the carboxy group of the intermediate and an epoxy group of a glycidyl(meth)acrylate to obtain ultraviolet curable resin containing terminal vinyl group, wherein the amount of the terminal vinyl group contained in the resin is at least 50% by weight, preferably at least 70% by weight, relative to total weight of the resin, and Tg of the resin is in a range of from 40˜100° C., preferably from 60˜90° C.

Accordingly, the present invention also relates to a process for preparing an ultraviolet curable resin, which comprises addition reaction of a (meth)acrylate and a glycidyl(meth)acrylate at a weight ratio of (meth)acrylate:glycidyl(meth)acrylate in a range of from 1:1 to 1:10 in the presence of polymerization initiator and solvent at a temperature of 60˜110° C., to obtain an intermediate having epoxy group; and subjecting to a ring-opening reaction between the epoxy of the intermediate and a carboxy group of an unsubstituted or substituted acrylic acid at an equivalent ratio of the carboxy group of the acrylic acid to the epoxy group of the intermediate in a range of from 1:1 to 1.25:1 in the presence of catalyst in amount of 1˜5% by weight at a temperature of 60˜110° C.

In the present process for preparing a ultraviolet curable resin, the (meth)acrylate can be used in one or more kinds. In case of using two or more kinds of (meth)acrylate, the ratio of each (meth)acrylate is not limited as long as the total weight of (meth)acrylate satisfies the weight ratio of (meth)acrylate:glycidyl(meth)acrylate in a range of from 1:1 to 1:10. Also, the unsubstituted or substituted acrylic acid can be used in one or more kinds. In case of using two or more kinds of acrylic acid, the ratio of each acrylic acid is not limited as long as the total weight of acrylic acid satisfies the equivalent ratio of the carboxy group of acrylic acid: the epoxy group of glycidyl (meth)acrylate in a range of from 1:1 to 1.25:1, preferably from 1:1 to 1.10:1, more preferably 1.05:1 so that the epoxy group can be ring-opened completely.

The present invention further relates to a process for preparing an ultraviolet curable resin, which comprises addition reaction of a (meth)acrylate and an unsubstituted or substituted acrylic acid at a weight ratio of (meth)acrylate:unsubstituted or substituted acrylic acid in a range of from 1:1 to 1:10 in the presence of polymerization initiator and solvent at a temperature of 60˜110° C., to obtain an intermediate having carboxy group; and subjecting to a ring-opening reaction between the carboxy group of the intermediate and an epoxy group of a glycidyl (meth)acrylate at an equivalent ratio of the carboxy group of the intermediate to the epoxy group of the glycidyl(meth)acrylate in a range of from 1:1 to 1.25:1 in the presence of catalyst in an amount of 15% by weight at a temperature of 60˜110° C.

In the present process for preparing an ultraviolet curable resin, the (meth)acrylate and the unsubstituted or substituted acrylic acid each can be used in one or more kinds. In case of using two or more kinds, the ratio of each (meth)acrylate and acrylic acid are not limited as long as their total weight each satisfies the weight ratio of (meth)acrylate:acrylic acid in a range of from 1:1 to 1:10. Also, the glycidyl(meth)acrylate is used in an amount of that the equivalent ratio of the carboxy group of the intermediate: the epoxy group of the glycidyl(meth)acrylate is in a range of from 1:1 to 1.25:1, preferably from 1:1 to 1.10:1, more preferably 1.05:1 so that the epoxy group can be ring-opened completely.

The Tg of the ultraviolet curable resin of the present invention is in a range of from 40˜100° C., preferably from 60˜90° C. If Tg is less than 40° C., the hardness of the film prepared from the resin would decrease. If Tg is higher than 100° C., the film prepared from the resin become brittle and its adhesion on substrate become poor. Therefore the Tg of the present resin is preferably in a range of from 40˜100° C., more preferably from 60˜90° C.

The ultraviolet curable resin composition according to the present invention comprises the present ultraviolet curable resin and one or more photoinitiators, wherein the photoinitiators are contained in the resin composition in an amount of from 0.1 to 10 parts by weight, based on the total weight of the composition as 100 parts by weight. In the ultraviolet curable resin composition of the present invention, it preferably further contains multi-functional compound as diluents. In addition to render the resin composition with viscosity suitable for coating, the multi-functional compound diluents provide more unsaturated bonds when the resin composition is subjected to photo-curing so that increase cross-linking between components during photo-curing process.

The term “diluent” used herein encompasses those of which molecular weight and viscosity are lower than the ultraviolet curable resin of the present invention.

### DETAILED DESCRIPTION OF THE INVENTION

As mentioned above, the ultraviolet curable resin of the present invention is prepared from a (meth)acrylate, a glycidyl(meth)acrylate, and a substituted or unsubstituted acrylic acid, wherein the resin contains terminal vinyl group in amount of at least 50 wt % based on the resin and its glass transition temperature (Tg) is in a range of from 40˜100° C., preferably from 60˜90° C.

As mentioned above, the process for preparing an ultraviolet curable resin of the present invention comprises addition reaction of a (meth)acrylate and a glycidyl(meth)acrylate at a weight ratio of (meth)acrylate:glycidyl(meth)acrylate in a range of from 1:1 to 1:10 in the presence of polymerization initiator and solvent at a temperature of 60˜110° C., to obtain an intermediate having epoxy group; and subjecting to a ring-opening reaction between the epoxy of the intermediate and a carboxy group of an unsubstituted or substituted acrylic acid at an equivalent ratio of the carboxy group of the acrylic acid to the epoxy group of the intermediate in a range of from 1:1 to 1.25:1 in the presence of catalyst in amount of 1˜5% by weight at a temperature of 60˜110° C.

In the present process for preparing a ultraviolet curable resin, the (meth)acrylate can be used in one or more kinds. In case of using two or more kinds of (meth)acrylate, the ratio of each (meth)acrylate is not limited as long as the total weight of (meth)acrylate satisfies the weight ratio of (meth)acrylate:glycidyl(meth)acrylate in a range of from 1:1 to 1:10. Also, the unsubstituted or substituted acrylic acid can be used in one or more kinds. In case of using two or more kinds of acrylic acid, the ratio of each acrylic acid is not limited as long as the total weight of the acrylic acid satisfies the equivalent ratio of the carboxy group of acrylic acid: the epoxy group of glycidyl(meth)acrylate in a range of from 1:1 to 1.25:1, preferably from 1:1 to 1.10:1, more preferably 1.05:1 so that the epoxy group can be ring-opened completely.

Another process for preparing an ultraviolet curable resin of the present invention comprises addition reaction of a (meth)acrylate and an unsubstituted or substituted acrylic acid at a weight ratio of (meth)acrylate:unsubstituted or substituted acrylic acid in a range of from 1:1 to 1:10 in the presence of polymerization initiator and solvent at a temperature of 60˜110° C., to obtain an intermediate having carboxy group; and subjecting to a ring-opening reaction between the carboxy group of the intermediate and an epoxy group of a glycidyl(meth)acrylate at an equivalent ratio of the carboxy group of the intermediate to the epoxy group of the glycidyl(meth)acrylate in a range of from 1:1 to 1.25:1 in the presence of catalyst in an amount of 1˜5% by weight at a temperature of 60˜110° C.

In the present process for preparing an ultraviolet curable resin, the (meth)acrylate and the unsubstituted or substituted acrylic acid each can be used in one or more kinds. In case of using two or more kinds, the ratio of each (meth)acrylate and acrylic acid are not limited as long as their total weight each satisfies the weight ratio of (meth)acrylate:acrylic acid in a range of from 1:1 to 1:10. Also, the glycidyl(meth)acrylate is used in an amount of that the equivalent ratio of the carboxy group of the intermediate: the epoxy group of the glycidyl(meth)acrylate is in a range of from 1:1 to 1.25:1, preferably from 1:1 to 1.10:1, more preferably 1.05:1 so that the epoxy group can be ring-opened completely.

The Tg of the ultraviolet curable resin of the present invention is in a range of from 40˜100° C., preferably from 60˜90° C. If Tg is less than 40° C., the hardness of the film prepared from the resin would decrease. If Tg is higher than 100° C., the film prepared from the resin become brittle and its adhesion on substrate become poor. Therefore the Tg of the present resin is preferably in a range of from 40˜100° C., more preferably from 60˜90° C.

Examples of the (meth)acrylate used in preparing the present ultraviolet curable resin includes, alkyl(meth)acrylate, for example, methyl acrylate, ethyl acrylate, propyl acrylate, isopropyl acrylate, n-butyl acrylate, isobutyl acrylate, tert-butyl acrylate, pentyl acrylate, hexyl acrylate, cyclohexyl acrylate, 2-ethylhexyl acrylate, octyl acrylate, isooctyl acrylate, decyl acrylate, isodecyl acrylate, 4-tert-butyl-cyclohexyl acrylate, tridecyl acrylate, lauryl acrylate, methyl methacrylate, ethyl methacrylate, propyl methacrylate, isopropyl methacrylate, n-butyl methacrylate, isobutyl methacrylate, tert-butyl methacrylate, pentyl methacrylate, hexyl methacrylate, cyclohexyl methacrylate, 2-ethylhexyl methacrylate, octyl methacrylate, isooctyl methacrylate, decyl methacrylate, isodecyl methacrylate, 4-tert-butyl-cyclohexyl methacrylate, tridecyl methacrylate, lauryl methacrylate; aralkyl(meth)acrylate, for example, benzyl acrylate, anthracenylmethyl acrylate, naphthyl acrylate, benzyl methacrylate, anthracenylmethyl methacrylate, naphthyl methacrylate; allyl acrylate, allyl methacrylate, 2-butoxyethyl acrylate, 2-butoxyethyl methacrylate, 2-ethoxyethyl acrylate, 2-ethoxyethyl methacrylate, fluorescein O-acrylate, fluorescein O-methacrylate, furfuryl acrylate, furfuryl methacrylate, 4-hydroxybutyl acrylate, 4-hydroxybutyl methacrylate, 2-hydroxyethyl acrylate, 2-hydroxyethyl methacrylate, 3-hydroxypropyl acrylate, 3-hydroxypropyl methacrylate, 6-hydroxyhexyl acrylate, 6-hydroxyhexyl methacrylate, isobomyl acrylate, isobornyl methacrylate, 2-isocyanatoethyl acrylate, 2-isocyanatoethyl methacrylate, lauryl acrylate, lauryl methacrylate, pentabromobenzyl acrylate, pentabromobenzyl methacrylate, tetrahydrofurfuryl acrylate, tetrahydrofurfuryl methacrylate, 2,4,6-tribromophenyl acrylate, 2,4,6-tribromophenyl methacrylate, 2,2,3,3,3-pentafluoropropyl acrylate, 2,2,3,3,3-pentafluoropropyl methacrylate, 2,2,3,3-tetrafluoropropyl acrylate, 2,2,3,3-tetrafluoropropyl methacrylate, 1,1,1,3,3,3-hexafluoro-isopropyl acrylate, 1,1,1,3,3,3-hexafluoroisopropyl methacrylate, 2,2,3,4,4,4-hexafluorobutyl acrylate, 2,2,3,4,4,4-hexafluorobutyl methacrylate, 2,2,3,3,4,4,4-heptafluorobutyl acrylate, 2,2,3,3,4,4,4-heptafluorobutyl methacrylate, 2,2,3,3,4,4,5,5,6,6,7,7,8,8,9,9-hexadeca-fluoro-nonyl acrylate, 2,2,3,3,4,4,5,5,6,6,7,7,8,8,9,9-hexadeca-fluoro-nonyl methacrylate, 3,3,4,4,5,5,6,6,7,7,8,8,9,9,10,10,10-heptadecafluoro-decyl acrylate, 3,3,4,4,5,5,6,6,7,7,8,8,9,9,10,10,10-heptadecafluoro-decyl methacrylate, 3,3,4,4,5,5,6,6,7,7,8,8,8-tridecafluorooctyl acrylate, 3,3,4,4,5,5,6,6,7,7,8,8,8-tridecafluorooctyl methacrylate, 2,2,3,3,4,4,5,5,6,6,7,7-dodecafluoroheptyl acrylate, 2,2,3,3,4,4,5,5,6,6,7,7-dodecafluoroheptyl methacrylate, 2,2,3,3,4,4,5,5,6,6,7,7,8,8,9,9,10,10,11,11-eicosafluoro-undecyl acrylate, 2,2,3,3,4,4,5,5,6,6,7,7,8,8,9,9,10,10,11,11-eicosafluoro-undecyl methacrylate, 3,3,4,4,5,5,6,6,7,7,8,8,9,9,10,10,11,11,12,12,12-heneicosafluorododecyl acrylate, 3,3,4,4,5,5,6,6,7,7,8,8,9,9,10,10,11,11,12,12,12-heneicosafluorododecyl methacrylate, 2,2,2-trifluoroethyl acrylate, 2,2,2-trifluoroethyl methacrylate, 3,3,5-trimethylcyclohexyl acrylate, 3,3,5-trimethylcyclohexyl methacrylate, trimethylsilyl acrylate, trimethylsilyl methacrylate, vinyl acrylate, vinyl methacrylate, 3-(acryloyloxy)-2-hydroxypropyl acrylate, 3-(acryloyloxy)-2-hydroxy-propyl methacrylate, 2-[3-(2H-benzotriazol-2-yl)-4-hydroxyphenyl]ethyl acrylate, 2-[3-(2H-benzotriazol-2-yl)-4-hydroxyphenyl]ethyl methacrylate, 2-(tert-butylamino)ethyl acrylate, 2-(tert-butylamino)ethyl methacrylate, 9H-carbazole-9-ethyl acrylate, 9H-carbazole-9-ethyl methacrylate, 2-(dimethylamino)ethyl acrylate, 2-(dimethylamino)ethyl methacrylate, 2-(diethylamino)ethyl acrylate, 2-(diethylamino)ethyl methacrylate, 3-(dimethylamino)propyl acrylate, 3-(dimethyl-amino)propyl methacrylate, 6-[4-(4-cyanophenyl)phenoxy]hexyl acrylate, 6-[4-(4-cyanophenyl)phenoxy]hexyl methacrylate, 2-carboxyethyl acrylate, 2-carboxyethyl methacrylate, 2-benzylethyl acrylate, 2-benzylethyl methacrylate, 2-[[(butylamino)carbonyl]oxy]ethyl acrylate, 2-[[(butylamino)carbonyl]oxy]ethyl methacrylate, 2-hydroxy-3-phenoxy-propyl acrylate, 2-hydroxy-3-phenoxypropyl methacrylate. Those (meth)acrylate can be used alone or as a mixture of two or more kinds.

Examples of the unsubstituted or substituted acrylic acid used in preparing the present ultraviolet curable resin includes, for examples, 2-(bromomethyl)acrylic acid, trans-3-(4-chlorobenzoyl)acrylic acid, 3-(2-furyl)acrylic acid, 4-imidazoleacrylic acid, 3-indoleacrylic acid, trans-3-(4-methoxybenzoyl)acrylic acid, 3-(phenylthio)acrylic acid, trans-3-(3-pyridyl)acrylic acid, 3-(2-thienyl)acrylic acid, trans-3-(3-thienyl)-acrylic acid, 2-(trifluoromethyl)acrylic acid, 3-[5-(4-chlorophenyl)-furan-2-yl]acrylic acid, 3,3-difluoro-2-(2-indolinyl-methyl)acrylic acid, 3,3-difluoro-2-(2-pyrrolidinylmethyl)acrylic acid, 3-(5-(2-nitrophenyl)-furan-2-yl)acrylic acid, 3-[5-(2-(trifluoromethyl)phenyl)furan-2-yl]-acrylic acid, 3-acenaphthen-5-yl-acrylic acid, 3-(5-acetoxy-2,4-dimthoxy-phenyl)-acrylic acid, 3-(5-acetyl-furan-2-yl)-acrylic acid, acrylic acid, methacrylic acid, 3-(4-(4-(4-acetyl-3-hydroxy-2-propyl-phenoxy)butoxy)phenyl)acrylic acid, 3-(4-(2-(4-acetyl-3-hydroxy-2-propyl-phenoxy)ethoxy)-3-methoxyphenyl)acrylic acid, 3-(benzhydrylidene-hydrazinocarbonyl)-acrylic acid, 3-benzo[1,3]dioxol-5-yl-acrylic acid, 3-benzo[1,3]dioxol-5-yl-2-cyano-acrylic acid, 2-benzoyl-amino-3,3-dichloro-acrylic acid, 2-benzoylamino-3-(4-dimethyl-amino-phenyl)-acrylic acid, 2-benzoylamino-3-(ethoxylphenyl-phosphinoyl)-3-phenyl-acrylic acid, 2-(benzoylamino)-3-(4-mthoxy-phenyl)-acrylic acid, 3-(1-benzyl-1H-indol-3-yl)-acrylic acid, 3-(benzylidene-hydrazinocarbonyl)-acrylic acid, 3-(5-(benzyloxy)-4-oxo-4H-pyran-2-yl)acrylic acid. Those acrylic acids can be used alone or as a mixture of two or more kinds.

Additionally, the process for preparing an ultraviolet curable resin of the present invention comprises addition reaction of a (meth)acrylate and a glycidyl(meth)acrylate at a weight ratio of (meth)acrylate:glycidyl(meth)acrylate in a range of from 1:1 to 1:10 in the presence of polymerization initiator (such as 2,2-azobis(2,4-dimethylvaleronitrile) (ADVN))and solvent (such as butyl acetate) at a temperature of 60˜110° C. for about 1˜5 hours, to obtain an intermediate having epoxy group; and subjecting to a ring-opening reaction between the epoxy of the intermediate and a carboxy group of an unsubstituted or substituted acrylic acid at an equivalent ratio of carboxy group of the acrylic acid to the epoxy group of the intermediate in a range of from 1:1 to 1.25:1, preferably from 1:1 to 1.10:1, more preferably 1.05:1, in the presence of catalyst (such as phosphines, for example, triphenylphosphine, phosphonium salts, for example, tetrabutylphosphonium O,O-diethyl phosphordithioate) in amount of 1˜5% by weight at a temperature of 60˜110° C.

Alternatively, the process for preparing an ultraviolet curable resin of the present invention comprises addition reaction of a (meth)acrylate and an unsubtituted or substituted acrylic acid at a weight ratio of (meth)acrylate:acrylic acid in a range of from 1:1 to 1:10 in the presence of polymerization initiator (such as 2,2-azobis(2,4-dimethylvaleronitrile) (ADVN)) and a solvent (such as butyl acetate) at a temperature of 60˜110° C. for about 1˜5 hours, to obtain an intermediate having carboxy group; and subjecting to a ring-opening reaction between the carboxy group of the intermediate and an epoxy group of a glycidyl(meth)acrylate at an equivalent ratio of carboxy group of the intermediate to the epoxy group of the glycidyl(meth)acrylate in a range of from 1:1 to 1.25:1, preferably from 1:1 to 1.10:1, more preferably 1.05:1, in the presence of catalyst (such as phosphines, for example, triphenylphosphine, phosphonium salts, for example, tetrabutylphosphonium O,O-diethyl phosphordithioate) in amount of 1˜5% by weight at a temperature of 60˜110° C.

According to the present ultraviolet curable resin, by controlling the ratio of (meth)acrylate to glycidyl(meth)acrylate and/or unsubstituted or substituted acrylic acid, it can obtain the resin having terminal vinyl group in amount of at least 50 wt % based on the resin and Tg is in a range of from 40˜100° C., preferably from 60˜90° C., thereby it is useful as a surface hardcoat on a substrate and attributes the substrate with high transparency, high hardness, excellent anti-scratching, anti-wearing, and anti-static properties.

Comparing with the ultraviolet curable resin prepared by using tertiary ammonium salt as catalyst, the ultraviolet curable resin of the present invention prepared by using phosphines or phosphonium salt as catalyst possesses higher transparency so that the final product prepared therefrom is less coloring.

Moreover, the ultraviolet curable resin composition of the present invention comprises the present ultraviolet curable resin and one or more photoinitiators, wherein the photoinitiators are contained in the resin composition in an amount of from 0.1 to 10 parts by weight, preferably from 1 to 10 parts by weight, based on the total weight of the composition as 100 parts by weight.

In formulating the ultraviolet curable resin composition of the present invention, the ultraviolet curable resin of the present invention is preferably used in a solid content of from 40˜80%. If the solid content is less than 40%, it is difficult to formulate into an ultraviolet curable resin composition, if it is more than 80%, the viscosity of resultant composition is too high to formulate.

The photoinitiator used in the ultraviolet curable resin composition can be any photoinitiator as long as it can generate free radical upon light irradiation. Examples of the photoinitiators include, but not limit to, benzoin, benzoin methyl ether, benzoin ethyl ether, benzoin isopropyl ether, benzoin butyl ether, benzoin isobutyl ether, benzoin benzoic acid, benzoin-methyl benzoate, benzoin dimethyl ketal, diethoxy acetophenone (for example, IRGACURE 651 commercial available from Ciba Special Chemical Co., Ltd.), 2-methyl-[4-(methylthio)phenyl]-2-morphline-1-prpanone (for example, IRGACURE 907 commercial available from Ciba Special Chemical Co., Ltd.), benzyl dimethyl ketal, 2-hydroxy-2-methyl-pripiophenone, 1-hydroxycyclohexyl phenyl ketone (for example, IRGACURE 184 commercial available from Ciba Special Chemical Co., Ltd.), benzophenone, Michler's ketone, isoamyl N,N-dimethylaminobenzoate, 2-chlorothioxanthone, 1-chloro-4-propoxy-thioxanthone, 2-isopropyl-thioxanthone (ITX), 2,4-diethyl-thioxanthone, acetophenone, benzyl diphenyl sulfide, tetramethylthiuram monosulfide, azobis-isobutyronitrile, benzyl, dibenzyl, diacetyl, β-chloro-anthraquinone, ethyl 4-(dimethylamino)benzoate, etc. Those photoinitors can be used alone or in a mixture of two or more kinds. Those photoinitors are used in an amount of from 0.1˜10 parts by weight, preferably 1˜9 parts by weight, based on 100 parts by weight of the ultraviolet curable resin composition.

In the ultraviolet curable resin composition of the present invention, it preferably further contains multi-functional compound as diluents. In addition to render the resin composition with viscosity suitable for coating, the multi-functional compound diluents provide more unsaturated bonds when the resin composition is subjected to photo-curing so that increase cross-linking between components during photo-curing process.

Examples of the multi-functional compound diluents include, for examples, dipentaerythritol hexaacrylate (DPHA), 1,4-butanediol diacrylate, neopentylglycol diacrylate, 1,6-hexanediol diacrylate, 2,2-bis[4-(acryloyloxy-diethoxy)phenyl]propane, bis(acryloyloxyethyl)-hydroxyethyl isocyanurate, tricyclodecanedimethyl diacrylate, trimethylolpropane triacrylate, pentaerythritol triacrylate, trimethylolpropane-propylene oxide adduct triacrylate, tris(acryloyloxyethyl)isocyanurate, pentaerythritol tetraacrylate, dipentaerythritol pentaacrylate, dipentaerythritol-caprolactone adduct acrylate, bisphenol A epoxy resin-acrylic acid adduct, and epoxy-novolak resin-acrylic acid adduct.

In addition to the multi-functional compound diluents, for easily applying the ultraviolet curable resin composition of the present invention onto a substrate, the resin composition is usually dissolved in a solvent so as to have a viscosity suitable for coating. The solvent which can be used includes aromatic hydrocarbons, e.g., ethylene dichloride; esters, e.g., methyl acetate, ethyl acetate, and butyl acetate; ketones, e.g., acetone, methyl ethyl ketone, and methyl isobutyl ketone; dioxane; and cellosolve solvents; or mixtures of two or more thereof.

The amount of the solvent is preferably selected to obtain a viscosity of the ultraviolet curable resin composition of the present invention in a range of from 10 to 30,000 cps at 25° C.

The ultraviolet curable resin composition of the present invention can further contain various additives commonly used in this kind of resin composition, such as heat polymerization inhibitor for preventing heat polymerization during preservation, e.g., hydroquinone, hydroquinone monomethyl ether, benzoquinone, catechol, p-t-butylcatechol, and phenothiazine; ultraviolet absorbents for improving film properties, e.g., salicyclic acid types, benzophenone types, benzotriazole types, and cyanoacrylate types; ultraviolet stabilizers, e.g., hindered amine types; anti block ahent; slip agent; leveling agent; and the like.

The substrate to be coated with the ultraviolet curable resin composition of the present invention as a protect layer can use any substrate, but it is preferable a substrate or article made from polymethyl methacrylate (PMMA) resin, polycarbonate (PC) resin, and polyethylene terephthalate (PET) and the like. As to the coating method, it is not limited as long as the method can give uniform and smooth coating. Example of the coating method includes roll coating method, die coating method, knife coating method, and the like. Its coating thickness varies depending on its final use, but the thickness is usually in a range of from 1 to 50 μm, preferably from 3 to 30 μm.

The present invention is now illustrated in great detail with reference to the following Examples which are only used to explain the present invention without limiting the scope of the present invention. The scope of the present invention should be defined by the appended claims.

### A. EXAMPLES

### Example 1

### Production of the Ultraviolet Curable Resin Composition of the Present Invention

Into a reactor was added with butyl acetate (BA) (326 g, 2.8 mol) at room temperature, the temperature was then increased to 80° C. and added drop-wise with ethyl acetate (EA)(30 g, 0.3 mol), methyl methacrylate (MMA) (30 g, 0.3 mol), and glycidyl methacrylate (GMA) (142 g, 1 mol). The mixture was reacted in the presence of 2,2-azobis-(2,4-dimethylvaleronitrile)(ADVN)(4.04 g, 0.016 mol) at a temperature of 80° C. for 3 hours. Then the temperature was increased to 100° C., and triphenylphosphine(TPP)(4.8 g, 0.018 mol) was added as a catalyst, and acrylic acid (AA)(80 g, 1.1 mol) was added drop-wise and reacted for 5 hours. Thereafter, the mixture was cooled to room temperature to obtain the ultraviolet curable resin A-1 of the present invention (260.3 g), which solid content was 42.75%, yield was 95%. The resin was detected with FTIR and found that the absorption peak at about 910 cm⁻¹, disappeared, which demonstrated that the epoxy of the GMA had been ring-opened completely, and there was an absorption peak at about 1635 cm⁻¹, which demonstrated that there still remained vinyl (—CH═CH—) functional group.

Additionally, the colority of the resin was tested by using colormeter (Model Lovibond 3000 comparator, Lovibond Co., Ltd, German) according to Gardener test method, and found to be 3.0. The conditions for determining the colority were as follows: concentration of the resin was 42.75%, sample was filled to test tube at ⅔ height, test was repeated three times, and the highest value was taken as the colority.

### Example 2

### Production of the Ultraviolet Curable Resin Composition of the Present Invention

Into a reactor was added with butyl acetate (BA) (326 g, 2.8 mol) at room temperature, the temperature was then increased to 80° C. and added drop-wise with ethyl acetate (EA)(30 g, 0.3 mol), methyl methacrylate (MMA) (30 g, 0.3 mol), and acrylic acid (AA) (80 g, 1.1 mol). The mixture was reacted in the presence of 2,2-azobis(2,4-dimethylvaleronitrile)(ADVN)(4.04 g, 0.016 mol) at a temperature of 80° C. for 3 hours. Then the temperature was increased to 100° C., and triphenylphosphine (TPP)(4.8 g, 0.018 mol) was added as a catalyst, and glycidyl methacrylate (GMA)(142 g, 1 mol) was added drop-wise and reacted for 5 hours. Thereafter, the mixture was cooled to room temperature to obtain the ultraviolet curable resin A-2 of the present invention (265.78 g), which solid content was 43.65%, yield was 97%. The resin was detected with FTIR and found that the absorption peak at about 910 cm⁻¹ disappeared, which demonstrated that the epoxy of the GMA had been ring-opened completely, and there was an absorption peak at about 1635 cm⁻¹, which demonstrated that there still remained vinyl (—CH═CH—) functional group.

Additionally, the colority of the resin was tested by using colormeter (Model Lovibond 3000 comparator, Lovibond Co., Ltd, German) according to Gardener test method, and found to be 3.0. The conditions for determining the colority were as follows: concentration of the resin was 43.65%, sample was filled to test tube at ⅔ height, test was repeated three times, and the highest value was taken as the colority.

### Example 3

### Production of the Ultraviolet Curable Resin Composition of the Present Invention

Into a reactor was added with butyl acetate (BA) (326 g, 2.8 mol) at room temperature, the temperature was then increased to 80° C. and added drop-wise with butyl acetate (BAR)(30 g, 0.23 mol), methyl methacrylate (MMA) (30 g, 0.3 mol), and glycidyl methacrylate (GMA) (142 g, 1 mol). The mixture was reacted in the presence of 2,2-azobis-(2,4-dimethylvaleronitrile)(ADVN)(4.04 g, 0.016 mol) at a temperature of 80° C. for 3 hours. Then the temperature was increased to 100° C., and triphenylphosphine (TPP)(4.8 g, 0.018 mol) was added as a catalyst, and acrylic acid (AA)(80 g, 1.1 mol) was added drop-wise and reacted for 5 hours. Thereafter, the mixture was cooled to room temperature to obtain the ultraviolet curable resin A-3 of the present invention (263.04 g), which solid content was 43.2%, yield was 96%. The resin was detected with FTIR and found that the absorption peak at about 910 cm⁻¹ disappeared, which demonstrated that the epoxy of the GMA had been ring-opened completely, and there was an absorption peak at about 1635 cm⁻¹, which demonstrated that there still remained vinyl (—CH═CH—) functional group.

Additionally, the colority of the resin was tested by using colormeter (Model Lovibond 3000 comparator, Lovibond Co., Ltd, German) according to Gardener test method, and found to be 3.0. The conditions for determining the colority were as follows: concentration of the resin was 43.2%, sample was filled to test tube at ⅔ height, test was repeated three times, and the highest value was taken as the colority.

### Example 4

### Production of the Ultraviolet Curable Resin Composition of the Present Invention

Into a reactor was added with butyl acetate (BA) (326 g, 2.8 mol) at room temperature, the temperature was then increased to 80° C. and added drop-wise with butyl acetate (BAR)(30 g, 0.23 mol), methyl methacrylate (MMA) (30 g, 0.3 mol), and acrylic acid (AA) (80 g, 1.1 mol). The mixture was reacted in the presence of 2,2-azobis(2,4-dimethylvaleronitrile)(ADVN)(4.04 g, 0.016 mol) at a temperature of 80° C. for 3 hours. Then the temperature was increased to 100° C., and triphenylphosphine (TPP)(4.8 g, 0.018 mol) was added as a catalyst, and glycidyl methacrylate (GMA)(142 g, 1 mol) was added drop-wise and reacted for 5 hours. Thereafter, the mixture was cooled to room temperature to obtain the ultraviolet curable resin A-4 of the present invention (257.56 g), which solid content was 42.3%, yield was 94%. The resin was detected with FTIR and found that the absorption peak at about 910 cm⁻¹ disappeared, which demonstrated that the epoxy of the GMA had been ring-opened completely, and there was an absorption peak at about 1635 cm⁻¹, which demonstrated that there still remained vinyl (—CH═CH—) functional group.

Additionally, the colority of the resin was tested by using colormeter (Model Lovibond 3000 comparator, Lovibond Co., Ltd, German) according to Gardener test method, and found to be 3.0. The conditions for determining the colority were as follows: concentration of the resin was 42.3%, sample was filled to test tube at ⅔ height, test was repeated three times, and the highest value was taken as the colority.

### Example 5

### Production of the Ultraviolet Curable Resin Composition of the Present Invention

Into a reactor was added with butyl acetate (BA) (326 g, 2.8 mol) at room temperature, the temperature was then increased to 80° C. and added drop-wise with ethyl acetate (EA)(15 g, 0.15 mol), butyl acrylate (BAR) (15 g, 0.115 mol), methyl methacrylate (MMA) (30 g, 0.3 mol), and glycidyl methacrylate (GMA) (142 g, 1 mol). The mixture was reacted in the presence of 2,2-azobis(2,4-dimethyl-valeronitrile) (ADVN)(4.04 g, 0.016 mol) at a temperature of 80° C. for 3 hours. Then the temperature was increased to 100° C., and triphenylphosphine (TPP)(4.8 g, 0.018 mol) was added as a catalyst, and acrylic acid (AA)(80 g, 1.1 mol) was added drop-wise and reacted for 5 hours. Thereafter, the mixture was cooled to room temperature to obtain the ultraviolet curable resin A-5 of the present invention (252.08 g), which solid content was 41.4%, yield was 92%. The resin was detected with FTIR and found that the absorption peak at about 910 cm⁻¹ disappeared, which demonstrated that the epoxy of the GMA had been ring-opened completely, and there was an absorption peak at about 1635 cm⁻¹, which demonstrated that there still remained vinyl (—CH═CH—) functional group.

Additionally, the colority of the resin was tested by using colormeter (Model Lovibond 3000 comparator, Lovibond Co., Ltd, German) according to Gardener test method, and found as 3.0. The conditions for determining the colority were as follows: concentration of the resin was 41.4%, sample was filled to test tube at ⅔ height, test was repeated three times, and the highest value was taken as the colority.

### Example 6

### Production of the Ultraviolet Curable Resin Composition of the Present Invention

Into a reactor was added with butyl acetate (BA) (326 g, 2.8 mol) at room temperature, the temperature was then increased to 80° C. and added drop-wise with ethyl acrylate (EA) (15 g, 0.15 mol), butyl acetate (BAR)(15 g, 0.115 mol), methyl methacrylate (MMA) (30 g, 0.3 mol), and acrylic acid (AA) (80 g, 1.1 mol). The mixture was reacted in the presence of 2,2-azobis(2,4-dimethylvaleronitrile)(ADVN)(4.04 g, 0.016 mol) at a temperature of 80° C. for 3 hours. Then the temperature was increased to 100° C., and triphenylphosphine (TPP)(4.8 g, 0.018 mol) was added as a catalyst, and glycidyl methacrylate (GMA)(142 g, 1 mol) was added drop-wise and reacted for 5 hours. Thereafter, the mixture was cooled to room temperature to obtain the ultraviolet curable resin A-6 of the present invention (253.89 g), which solid content was 41.85%, yield was 93%. The resin was detected with FTIR and found that the absorption peak at about 910 cm⁻¹ disappeared, which demonstrated that the epoxy of the GMA had been ring-opened completely, and there was an absorption peak at about 1635 cm⁻¹, which demonstrated that there still remained vinyl (—CH═CH—) functional group.

Additionally, the colority of the resin was tested by using colormeter (Model Lovibond 3000 comparator, Lovibond Co., Ltd, German) according to Gardener test method, and found to be 3.0. The conditions for determining the colority were as follows: concentration of the resin was 41.85%, sample was filled to test tube at ⅔ height, test was repeated three times, and the highest value was taken as the colority.

### Example 7

### Production of the Ultraviolet Curable Resin Composition of the Present Invention

Into a reactor was added with butyl acetate (BA) (61 g, 0.52 mol) at room temperature, the temperature was then increased to 80° C. and added drop-wise with ethyl acetate (EA)(30 g, 0.3 mol), methyl methacrylate (MMA) (30 g, 0.3 mol), and glycidyl methacrylate (GMA) (142 g, 1 mol). The mixture was reacted in the presence of 2,2-azobis(2,4-dimethyl-valeronitrile)(ADVN)(4.04 g, 0.016 mol) at a temperature of 80° C. for 3 hours. Then the temperature was increased to 100° C., and triphenylphosphine (TPP)(4.8 g, 0.018 mol) was added as a catalyst, and acrylic acid (AA)(80 g, 1.1 mol) was added drop-wise and reacted for 5 hours. Thereafter, the mixture was cooled to room temperature to obtain the ultraviolet curable resin A-7 of the present invention (260.3 g), which solid content was 76%, yield was 95%. The resin was detected with FTIR and found that the absorption peak at about 910 cm⁻¹ disappeared, which demonstrated that the epoxy of the GMA had been ring-opened completely, and there was an absorption peak at about 1635 cm⁻¹, which demonstrated that there still remained vinyl (—CH═CH—) functional group. Additionally, the colority of the resin was tested by using colormeter (Model Lovibond 3000 comparator, Lovibond Co., Ltd, German) according to Gardener test method, and found to be 4.0. The conditions for determining the colority were as follows: concentration of the resin was 76%, sample was filled to test tube at ⅔ height, test was repeated three times, and the highest value was taken as the colority.

### Example 8

### Production of the Ultraviolet Curable Resin Composition of the Present Invention

Into a reactor was added with butyl acetate (BA) (61 g, 0.52 mol) at room temperature, the temperature was then increased to 80° C. and added drop-wise with ethyl acrylate (EA) (30 g, 0.3 mol), methyl methacrylate (MMA) (30 g, 0.3 mol), and acrylic acid (AA) (80 g, 1.1 mol). The mixture was reacted in the presence of 2,2-azobis(2,4-dimethyl-valeronitrile)(ADVN)(4.04 g, 0.016 mol) at a temperature of 80° C. for 3 hours. Then the temperature was increased to 100° C., and triphenylphosphine (TPP)(4.8 g, 0.018 mol) was added as a catalyst, and glycidyl methacrylate (GMA)(142 g, 1 mol) was added drop-wise and reacted for 5 hours. Thereafter, the mixture was cooled to room temperature to obtain the ultraviolet curable resin A-8 of the present invention (265.78 g), which solid content was 77.6%, yield was 97%. The resin was detected with FTIR and found that the absorption peak at about 910 cm⁻¹ disappeared, which demonstrated that the epoxy of the GMA had been ring-opened completely, and there was an absorption peak at about 1635 cm⁻¹, which demonstrated that there still remained vinyl (—CH═CH—) functional group.

Additionally, the colority of the resin was tested by using colormeter (Model Lovibond 3000 comparator, Lovibond Co., Ltd, German) according to Gardener test method, and found to be 4.0. The conditions for determining the colority were as follows: concentration of the resin was 77.6%, sample was filled to test tube at ⅔ height, test was repeated three times, and the highest value was taken as the colority.

### Example 9

### Production of the Ultraviolet Curable Resin Composition of the Present Invention

Into a reactor was added with butyl acetate (BA) (61 g, 0.52 mol) at room temperature, the temperature was then increased to 80° C. and added drop-wise with butyl acetate (BAR)(30 g, 0.23 mol), methyl methacrylate (MMA) (30 g, 0.3 mol), and glycidyl methacrylate (GMA) (142 g, 1 mol). The mixture was reacted in the presence of 2,2-azobis(2,4-dimethyl-valeronitrile) (ADVN)(4.04 g, 0.016 mol) at a temperature of 80° C. for 3 hours. Then the temperature was increased to 100° C., and triphenylphosphine (TPP)(4.8 g, 0.018 mol) was added as a catalyst, and acrylic acid (AA)(80 g, 1.1 mol) was added drop-wise and reacted for 5 hours. Thereafter, the mixture was cooled to room temperature to obtain the ultraviolet curable resin A-9 of the present invention (263.04 g), which solid content was 76.8%, yield was 96%. The resin was detected with FTIR and found that the absorption peak at about 910 cm⁻¹ disappeared, which demonstrated that the epoxy of the GMA had been ring-opened completely, and there was an absorption peak at about 1635 cm⁻¹, which demonstrated that there still remained vinyl (—CH═CH—) functional group.

Additionally, the colority of the resin was tested by using colormeter (Model Lovibond 3000 comparator, Lovibond Co., Ltd, German) according to Gardener test method, and found to be 4.0. The conditions for determining the colority were as follows: concentration of the resin was 76.8%, sample was filled to test tube at ⅔ height, test was repeated three times, and the highest value was taken as the colority.

### Example 10

### Production of the Ultraviolet Curable Resin Composition of the Present Invention

Into a reactor was added with butyl acetate (BA) (61 g, 0.52 mol) at room temperature, the temperature was then increased to 80° C. and added drop-wise with butyl acrylate (BAR) (30 g, 0.23 mol), methyl methacrylate (MMA) (30 g, 0.3 mol), and acrylic acid (AA) (80 g, 1.1 mol). The mixture was reacted in the presence of 2,2-azobis(2,4-dimethyl-valeronitrile)(ADVN)(4.04 g, 0.016 mol) at a temperature of 80° C. for 3 hours. Then the temperature was increased to 100° C., and triphenylphosphine (TPP)(4.8 g, 0.018 mol) was added as a catalyst, and glycidyl methacrylate (GMA)(142 g, 1 mol) was added drop-wise and reacted for 5 hours. Thereafter, the mixture was cooled to room temperature to obtain the ultraviolet curable resin A-10 of the present invention (257.56 g), which solid content was 75.2%, yield was 94%. The resin was detected with FTIR and found that the absorption peak at about 910 cm⁻¹ disappeared, which demonstrated that the epoxy of the GMA had been ring-opened completely, and there was an absorption peak at about 1635 cm⁻¹, which demonstrated that there still remained vinyl (—CH═CH—) functional group.

Additionally, the colority of the resin was tested by using colormeter (Model Lovibond 3000 comparator, Lovibond Co., Ltd, German) according to Gardener test method, and found to be 4.0. The conditions for determining the colority were as follows: concentration of the resin was 75.2%, sample was filled to test tube at ⅔ height, test was repeated three times, and the highest value was taken as the colority.

### Example 11

### Production of the Ultraviolet Curable Resin Composition of the Present Invention

Into a reactor was added with butyl acetate (BA) (61 g, 0.52 mol) at room temperature, the temperature was then increased to 80° C. and added drop-wise with ethyl acetate (EA)(15 g, 0.15 mol), butyl acrylate (BAR) (15 g, 0.115 mol), methyl methacrylate (MMA) (30 g, 0.3 mol), and glycidyl methacrylate (GMA) (142 g, 1 mol). The mixture was reacted in the presence of 2,2-azobis(2,4-dimethyl-valeronitrile) (ADVN)(4.04 g, 0.016 mol) at a temperature of 80° C. for 3 hours. Then the temperature was increased to 100° C., and triphenylphosphine (TPP)(4.8 g, 0.018 mol) was added as a catalyst, and acrylic acid (AA)(80 g, 1.1 mol) was added drop-wise and reacted for 5 hours. Thereafter, the mixture was cooled to room temperature to obtain the ultraviolet curable resin A-11 of the present invention (252.08 g), which solid content was 73.6%, yield was 92%. The resin was detected with FTIR and found that the absorption peak at about 910 cm⁻¹ disappeared, which demonstrated that the epoxy of the GMA had been ring-opened completely, and there was an absorption peak at about 1635 cm⁻¹, which demonstrated that there still remained vinyl (—CH═CH—) functional group.

Additionally, the colority of the resin was tested by using colormeter (Model Lovibond 3000 comparator, Lovibond Co., Ltd, German) according to Gardener test method, and found to be 4.0. The conditions for determining the colority were as follows: concentration of the resin was 73.6%, sample was filled to test tube at ⅔ height, test was repeated three times, and the highest value was taken as the colority.

### Example 12

### Production of the Ultraviolet Curable Resin Composition of the Present Invention

Into a reactor was added with butyl acetate (BA) (61 g, 0.52 mol) at room temperature, the temperature was then increased to 80° C. and added drop-wise with ethyl acetate (15 g, 0.15 mol), butyl acrylate (BAR) (15 g, 0.115 mol), methyl methacrylate (MMA) (30 g, 0.3 mol), and acrylic acid (AA) (80 g, 1.1 mol). The mixture was reacted in the presence of 2,2-azobis(2,4-dimethyl-valeronitrile)(ADVN)(4.04 g, 0.016 mol) at a temperature of 80° C. for 3 hours. Then the temperature was increased to 100° C., and triphenylphosphine (TPP)(4.8 g, 0.018 mol) was added as a catalyst, and glycidyl methacrylate (GMA)(142 g, 1 mol) was added drop-wise and reacted for 5 hours. Thereafter, the mixture was cooled to room temperature to obtain the ultraviolet curable resin A-12 of the present invention (253.89 g), which solid content was 74.4%, yield was 93%. The resin was detected with FTIR and found that the absorption peak at about 910 cm⁻¹ disappeared, which demonstrated that the epoxy of the GMA had been ring-opened completely, and there was an absorption peak at about 1635 cm⁻¹, which demonstrated that there still remained vinyl (—CH═CH—) functional group.

Additionally, the colority of the resin was tested by using colormeter (Model Lovibond 3000 comparator, Lovibond Co., Ltd, German) according to Gardener test method, and found to be 4.0. The conditions for determining the colority were as follows: concentration of the resin was 74.4%, sample was filled to test tube at ⅔ height, test was repeated three times, and the highest value was taken as the colority.

### B. Formulation of Ultraviolet Curable Resin Composition of the Present Invention

### Formulation Example 1

50 g of the ultraviolet curable resin A-1 prepared from Example 1, 22.5 g of dipentaerythritol hexaacrylate (DPHA) as diluents, 1.125 g of IRGACURE 651(diethoxyacetophenone, manufactured and sold by Ciba Special Chemical Co., Ltd.), 0.337 g of IRGACURE 907 (2-methyl-[4-(methylthio)phenyl]-2-morphorline-1-prpanone, manufactured and sold by Ciba Special Chemical Co., Ltd.), and 0.112 g of ITX(2-isopropyl thioxanthone) are mixture at room temperature in a yellow room to obtain the ultraviolet curable resin composition of the present invention.

### Formulation Example 2

50 g of the ultraviolet curable resin A-2 prepared from Example 2, 22.5 g of dipentaerythritol hexaacrylate (DPHA) as diluents, 1.125 g of IRGACURE 651(diethoxyacetophenone, manufactured and sold by Ciba Special Chemical Co., Ltd.), 0.337 g of IRGACURE 907 (2-methyl-[4-(methylthio)phenyl]-2-morphorline-1-prpanone, manufactured and sold by Ciba Special Chemical Co., Ltd.), and 0.112 g of ITX(2-isopropyl thioxanthone) were mixed at room temperature in a yellow room to obtain the ultraviolet curable resin composition of the present invention.

### Experiment Example

The ultraviolet curable resin composition prepared above was coating on a polyethylene terephthalate (PET) substrate to a dry thickness of 10˜30 μm, baked at 50˜100° C. for 10˜50 minutes, then cured by irradiating with ultraviolet lamp at an exposure intensity of 200˜2000 mJ/cm², to obtain a hard coat. The resultant hard coat was measured its pencil hardness by using pencil tester. In case of exposure strength of 220 mj/cm² and dry thickness of 15 μm, the pencil hardness of the resultant hard coat is 2H, and in case of exposure strength of 440 mJ/cm² and dry thickness of 15 μm, the pencil hardness of the resultant hard coat is 3H. The resultant hard coat having a dry thickness of 15 μm was also measured its light transmission by using Portable B & W Transmission densitometer Ihac-T5 (Ihara Electronic Industries Co., Ltd, Japan) and found to be more than 95%.

As mentioned above, since phosphine or phosphonium salt is used as catalyst in preparing the ultraviolet curable resin of the present invention, the resultant ultraviolet curable resin can be processed into final product with high transparency and without coloring problem. Moreover, by adjusting the ratio of (meth)acrylate to glycidyl(meth)acrylate, it can obtain a ultraviolet curable resin having Tg in a range of from 40˜100° C., preferably from 60˜90° C., thereby the resin is more suitable in hard coat application to attain high transparency, high hardness, excellent anti-scratching, anti-wearing, and anti-static properties.

What is claimed is:

1. A ultraviolet curable resin, which is prepared from (meth)acrylates, glycidyl(meth)acrylate, and substituted or unsubstituted acrylic acid, wherein the resin contains terminal vinyl group in amount of at least 50 wt % based on the resin and its glass transition temperature (Tg) is in a range of from 40˜100° C.

2. The ultraviolet curable resin of claim 1, wherein the resin contains terminal vinyl group in amount of at least 70 wt % based on the resin.

3. The ultraviolet curable resin of claim 1, wherein the resin has a Tg of from 60˜90° C.

4. The ultraviolet curable resin of claim 1, wherein the resin is prepared by addition reacting of (meth)acrylate with glycidyl(meth)acrylate to obtain an intermediate having epoxy group, then subjecting to an ring-open reaction between the epoxy of the intermediate and a carboxy group of unsubstituted or substituted acrylic acid.

5. The ultraviolet curable resin of claim 4, wherein the addition reacting of (meth)acrylate and glycidyl(meth)acrylate is carried out at a weight ratio of (meth)acrylate:glycidyl(meth)acrylate in a range of from 1:1 to 1:10.

6. The ultraviolet curable resin of claim 5, wherein the unsubstituted or substituted acrylic acid is used in an amount that an equivalent ratio of carboxy group of the acrylic acid to the epoxy group of the intermediate is in a range of from 1:1 to 1.25:1.

7. The ultraviolet curable resin of claim 1, wherein the resin is prepared by addition reacting of (meth)acrylate with unsubstituted or substituted acrylic acid to obtain an intermediate having carboxy group, then subjecting to an ring-open reaction between the carboxy of the intermediate and an epoxy group of glycidyl(meth)acrylate.

8. The ultraviolet curable resin of claim 7, wherein the addition reacting of (meth)acrylate and the unsubstituted or substituted acrylic acid is carried out at a weight ratio of (meth)acrylate:the unsubstituted or substituted acrylic acid in a range of from 1:1 to 1:10.

9. The ultraviolet curable resin of claim 8, wherein the glycidyl(meth)acrylate is used in an amount that an equivalent ratio of carboxy group of the intermediate to the epoxy group of the glycidyl(meth)acrylate is in a range of from 1:1 to 1.25:1.

10. A process for preparing a ultraviolet curable resin, which comprises addition reacting (meth)acrylate and glycidyl(meth)acrylate at a weight ratio of (meth)acrylate:glycidyl(meth)acrylate in a range of from 1:1 to 1:10 in the presence of polymerization initiator and solvent at a temperature of 60˜110° C., to obtain an intermediate having epoxy group; and subjecting to an ring-open reaction between the epoxy of the intermediate and a carboxy group of an unsubstituted or substituted acrylic acid at an equivalent ratio of carboxy group of the acrylic acid to the epoxy group of the intermediate in a range of from 1:1 to 1.25:1 in the presence of catalyst in amount of 1˜5% by weight at a temperature of 60˜110° C.

11. The process of claim 10, wherein the catalyst is phosphines or phosphonium salt.

12. A process for preparing a ultraviolet curable resin, which comprises addition reacting (meth)acrylate and unsubstituted or substituted acrylic acid at a weight ratio of (meth)acrylate:unsubstituted or substituted acrylic acid in a range of from 1:1 to 1:10 in the presence of polymerization initiator and solvent at a temperature of 60˜110° C., to obtain an intermediate having carboxy group; and subjecting to an ring-open reaction between the carboxy group of the intermediate and a epoxy group of glycidyl(meth)acrylate at an equivalent ratio of carboxy group of the intermediate to the epoxy group of the glycidyl(meth)acrylate in a range of from 1:1 to 1.25:1 in the presence of catalyst in amount of 1˜5% by weight at a temperature of 60˜110° C.

13. The process of claim 12, wherein the catalyst is phosphines or phosphonium salt.

14. An ultraviolet curable resin composition, comprises the ultraviolet curable resin of claim 1 and one or more photoinitiators, wherein the photoinitiator(s) is(are) contained in the resin composition in an amount of from 0.1 to 10 parts by weight, based on the total weight of the composition as 100 parts by weight.

15. The ultraviolet curable resin composition of claim 14, wherein the photoinitiator(s) is(are) contained in the resin composition in an amount of from 1 to 10 parts by weight, based on the total weight of the composition as 100 parts by weight.

16. The ultraviolet curable resin composition of claim 14, wherein the photoinitiators are one or more selected from the group consisting of benzoin, benzoin methyl ether, benzoin ethyl ether, benzoin isopropyl ether, benzoin butyl ether, benzoin isobutyl ether, benzoin benzoic acid, benzoin-methyl benzoate, benzoin dimethyl ketal, diethoxy acetophenone, 2-methyl-[4-(methylthio)phenyl]-2-morphline-1-prpanone, benzyl dimethyl ketal, 2-hydroxy-2-methyl-pripiophenone, 1-hydroxycyclohexyl phenyl ketone, benzophenone, Michler's ketone, isoamyl N,N-dimethylaminobenzoate, 2-chlorothioxanthone, 1-chloro-4-propoxy-thioxanthone, 2-isopropyl-thioxanthone (ITX), 2,4-diethyl-thioxanthone, acetophenone, benzyl diphenyl sulfide, tetramethylthiuram monosulfide, azobisisobutyronitrile, benzyl, dibenzyl, diacetyl, β-chloroanthraquinone, and ethyl 4-(dimethylamino)benzoate.

17. The ultraviolet curable resin composition of claim 14, which further contains multi-functional compound as diluents.
